(19) United States
(12) Patent Application Publication
(10) Pub. No.: US 2007/0150892 A1
(43) Pub. Date: Jun. 28, 2007

(54) Scheduled delivery of software download

(75) Inventor: John William Chaney, Gilroy, CA (US)

Correspondence Address: Kenneth L. Sherman, Esq.;Myers Dawes Andras & Sherman, LLP, 11th Floor, 19900 MacArthur Blvd., Irvine, CA, 92612, US

(73) Assignee: Samsung Electronics Co., Ltd., Suwon City (KR)

(21) Appl. No.: 11/317,825

(22) Filed: Dec. 22, 2005

(51) Int. Cl. G06F 9/445; G06F 9/44

(52) U.S. Cl. 717/177; 717/168; 717/174; 717/171; 717/176; 717/172

(57) ABSTRACT

An OCAP software download method improves the efficiency of software download in the OCAP for delivering operational software to consumer STBs. The download method allows many STBs to receive the software that is streamed from the cable headend over the cable plant to the STBs. Rather than servicing one STB per request, the download method utilizes a scheduled download method with synchronization and broadcasting protocol to allow many STBs to receive the data sent in one request.

### FIELD OF THE INVENTION

The present invention relates to Open Cable Application Protocol (OCAP), and in particular to improving efficiency of the software download in OCAP.

### BACKGROUND OF THE INVENTION

OCAP is a middleware software layer intended to enable development of interactive television services and applications that run successfully on any cable television system in North America, independent of set-top or television receiver hardware or operating system software choices. OCAP enables manufacturers, distributors and operators of set-top boxes, television receivers or other devices to provide to consumers devices that support services delivered by cable operators to devices currently available to consumers via lease from cable operators.

To supply applications to consumers, cable operators utilize cable headend devices that can transmit OCAP applications and software to consumer set-top boxes (STB). The software download to be used in the OCAP, supplies operational software to consumer's STBs.

Several methods presently exist to download operational software to STBs via the cable plant which comprises the physical infrastructure (e.g., wire, connectors, cables, etc.) used to carry data communications signals between data communications equipment. One existing software download method utilizes the Trivial File Transfer Protocol (Tftp) method over a DOCSIS channel, wherein DOCSIS is Data Over Cable Service Interface Specification which defines interface standards for cable modems and supporting equipment. This allows downloading operation software to consumer STBs. However, a deficiency of this down mechanism method is that its loads one STB at a time. The Tftp method is inherently inefficient since it services one STB per request.

Another existing method of downloading operational software to STBs utilizes an In-Band (IB) scheme using Quadrature Amplitude Modulation (QAM) channels for transferring binary data over cable. This method delivers a stream of software using carousels of different versions to be sent to different brand STBs. However, such a method requires tremendous bandwidth that can otherwise be used for the delivery of video content, and further requires retransmitting the same data many times to account for reception errors.

### BRIEF SUMMARY OF THE INVENTION

In one embodiment the present invention provides a method and system that improves the efficiency of software download in the OCAP for delivering operational software to consumer STBs. A download method according to the present invention allows many STBs to receive the software that is streamed from the cable headend over the cable plant to the STBs.

In one implementation of such a download method, the present invention provides a scheduled software downloading method that can provide the download to many devices with one transmittal of the content. The conventional Tftp software download method is inherently inefficient since it services one STB per OCAP request. According to an embodiment of the present invention, that efficiency is improved by allowing many STBs to receive the data sent in one Tftp request.

These and other embodiments, features and advantages of the present invention will be apparent from the following specification taken in conjunction with the following drawings.

### BRIEF DESCRIPTION OF THE DRAWINGS

FIG. 1 shows an example block diagram of components of an example cable communications system for application delivery, implementing a scheduled software download method according to an embodiment the present invention.

FIG. 2 shows an event diagram of a conventional Tftp protocol.

FIG. 3 shows a flowchart of example steps of the scheduled software delivery according to an embodiment of the present invention as implemented in FIG. 1.

FIG. 4 shows a flowchart of additional example steps of the scheduled software delivery according to an embodiment of the present invention as implemented in FIG. 1.

### DETAILED DESCRIPTION OF THE INVENTION

In one embodiment the present invention provides a method and system that improves the efficiency of software download in the OCAP for delivering operational software to consumer STBs. A download method according to the present invention allows many STBs to receive the software that is streamed from the headend over the cable plant to the STBs.

In one implementation of such a download method, the present invention provides a scheduled software downloading method that can provide the download to many devices with one transmittal of the content. The conventional Tftp method is inherently inefficient since it services one STB per OCAP request.

According to an embodiment of the present invention, that efficiency is improved by allowing many STBs to receive the data sent in one request/transmission.

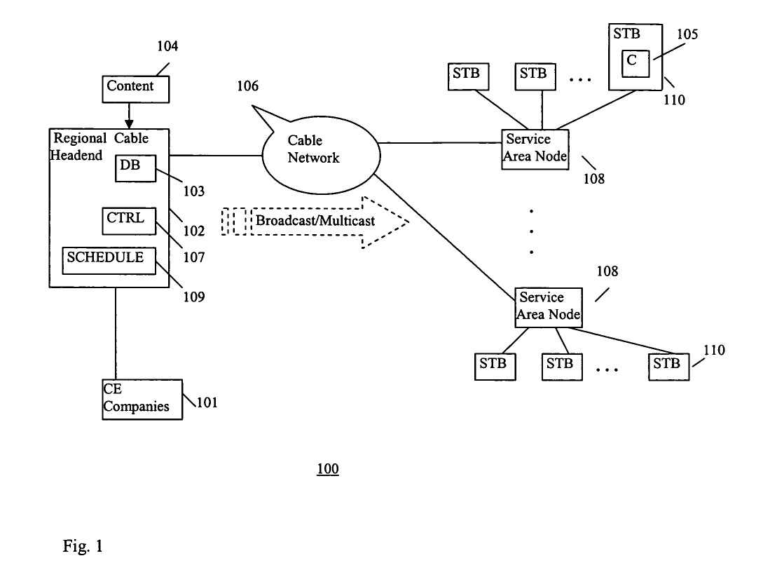

FIG. 1 shows an example block diagram of components of an example cable communications system 100 for application delivery, implementing a scheduled software download method according to an embodiment the present invention.

The system 100 includes a regional cable headend (CHE) 102 which provides content 104 (programming, software, application, etc.) via a cable network 106 to service nodes 108 for delivery to corresponding STBs 110. The system 100 implements said download method including synchronization and a broadcast protocol according to the present invention.

The scheduled download method according to the present invention is an improvement over the conventional Tftp method which is inherently inefficient since it services one STB per OCAP request.

Tftp is part of the Internet Protocol (IP) and is a simplified version of File Transfer Protocol (FTP) that allows files to be transferred from one device to another over a network. Tftp uses the User Datagram Protocol (UDP). As Tftp is a simplified version of FTB, Tftp can only read and write files from/to a remote server. According to TFTP PROTOCOL (RFC 1350, Sollins, K. 1992, Request for Comments: 1350 the TFTP Protocol (Revision 2), July 1992, IETF), any transfer begins with a request to read or write a file, which also serves to request a connection. If the server grants the request, the connection is opened and the file is sent in fixed length blocks. Both machines involved in a transfer are considered senders and receivers. One sends data and receives acknowledgments and the other sends acknowledgments and receives data. The fixed length blocks make allocation straight forward, and the lock step acknowledgement provides flow control and eliminates the need to reorder incoming data packets.

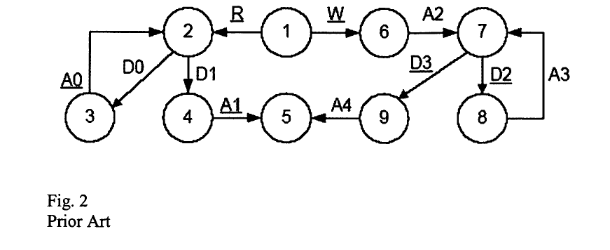

In a conventional Tftp software download method, each STB communicates with the cable headend for data transfer (both the STB and the cable headend are considered senders and receivers). FIG. 2 shows a conventional event block diagram of Tftp transfer without error handling and time-out, showing a transfer, described in: “A Functional Method for Assessing Protocol Implementation Security”, by Rauli Kaksonen, VTT Publications, 2001, www.inf.vtt.fi/pdf/publications/2001/P448.pdf, pages 27-28. The nodes are numbered from 1 to 9, and the edges labeled with event names. Input events are underlined to separate them from output events. The graph is based on the specification if the Tftp server (RFC 1350, Sollins, K. 1992, Request for Comments: 1350 the TFTP Protocol (Revision 2), July 1992, IETF. 11 p. The graph in FIG. 2 shows a single transfer, initiated by the client to a Tftp sever. In a read transfer the client downloads a file from the sever, and in a write transfer the client uploads a file to the server, wherein the file is transferred in data blocks. Table 1 below explains the edge labels used in FIG. 1.

TABLE 1

| Label | Explanation |
|---|---|
| R | Client requests a file read. |
| D0 | Server sends a 512-octet data block. |
| A0 | Client acknowledges the previous 512-octet data block. |
| D1 | Server sends the final data block, less than 512 octets. |
| A1 | Client acknowledges the final data block. |
| W | Client requests a file write. |
| A2 | Server acknowledges the readiness to receive. |
| D2 | Client sends a 512-octet data block. |
| A3 | Server acknowledges the previous 512-octet data block. |
| D3 | Client sends the final data block, less than 512 octets. |
| A4 | Server acknowledges the final data block. |

The conventional Tftp software download method is inherently inefficient since it services one STB per OCAP request. According to one implementation of the present invention, a scheduled software downloading method can provide the download to many devices with one transmittal of the content.

Synchronization is provided in the present invention by requiring each STB 110 (FIG. 2) to maintain the same clock in Universal Time as the cable headend CHE 102 and utilizing a scheduled delivery of software download protocol to allow the clocks to be synchronized to within a specified period such as e.g. 0.1 second. This allows many STBs to receive the data sent in one request.

The request can be from STB 110 or other nodes external to the CHE 102. Synchronization can be achieved via communication between the CHE 102 and the STBs 110 through the network 106 or other means which allows the STBs 110 t0 maintain the same clock in Universal Time as the cable headend CHE 102.

In one example implementation according to the present invention, a controller 107 in the cable headend (CHE) 102 receives requests from consumer electronics (CE) companies 101 to download new software to certain STBs 110. The CHE 102 maintains a database 103 of STBs 110 connected to its network (i.e., cable plant) 106, wherein the database 103 includes manufacturer, model number, and network address of each STB 110. The controller 107 queries the database 103 and constructs the list of possible STBs 110 that require a certain download. Also, such a list can contain items that are inserted because the STB itself has requested a download.

The controller 107 contacts all STBs 110 on the list and notifies them the particular time at which a software download will take place. Then, using its Universal Time clock 105, each STB 110 on the list joins the broadcast reception group at that particular time, wherein the controller 107 performs a single software transmission process (i.e., broadcast, multicast, etc.) such that each STB 110 receives the software delivered (broadcast, multicast, etc.) from the CHE 102 at the particular time.

For synchronization, each STB 110 maintains the same clock in Universal Time as the cable headend CHE 102. The controller 107 of the CHE 102 uses a scheduler 109 in the CHE 102 for scheduled delivery of software download. This allows the clocks to be synchronized to within a specified period such as e.g. 0.1 second. As such many STBs can receive the data sent in one request. The request can be from STB 110 or other nodes external to the CHE 102.

A scheduled software download according to the present invention synchronizes the components on the network, then STBs (or other type of control) request download, wherein the CHE downloads to multiple STBs a desired program all at once based on a schedule. The STBs know what time of day it is that they can just receive the download. The CHE selects the download rate based on the characteristics of the devices (e.g., STBs) obtained ahead of time, so that the CHE need not get involved in intricate handshake (like TFT) with the STBs. As such, each STB receives the download at a particular rate (e.g., lowest common denominator, or slowest STB receive rate, etc.), whereby many STBs can be accommodated.

After the single software transmittal process from the CHE 102, each such STB 110 checks its received software via the method supplied by its manufacturer. If the software check is successful, then the download process is complete. If not, then the STB 110 requests the CHE 102 for another transmission. The CHE 102 repeats the transmission until all such requests have been fulfilled.

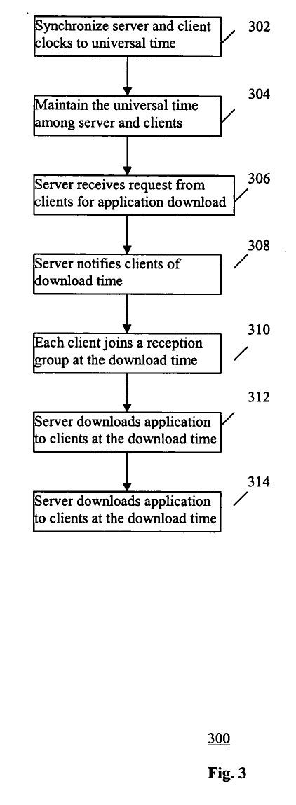

FIG. 3 shows a flowchart 300 of the example steps of the scheduled software delivery according to an embodiment of the present invention (e.g., as implemented in the system of FIG. 1), including the steps of:
Step 302: synchronizing a clock in each user device with a universal time at the server;
Step 304: maintaining the universal time in each client device in order to maintain synchronization with the sever;
Step 306: server receives requests from clients for application download;
Step 308: the server notifying the client devices of a particular time at which the application delivery will take place;
Step 310: each client device joining a broadcast reception group when the clock in each client device indicates said particular time;
Step 312: on or about the particular time, the server performing a single transmission process to broadcast/multicast the application over the delivery network;
Step 314: each client device receiving the application broadcast/multicast from the server over the delivery network at the particular time.

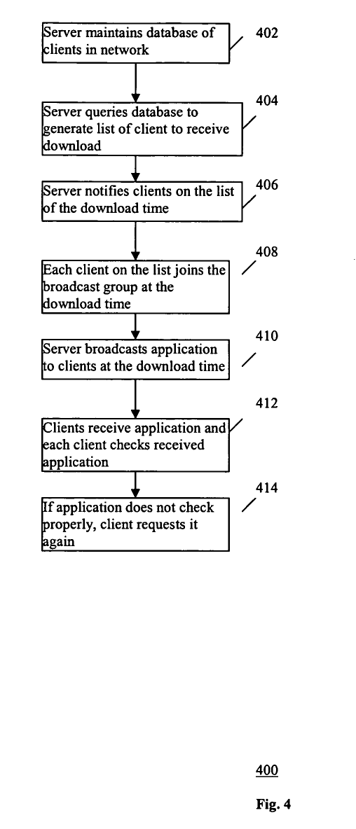

Referring to the example flowchart 400 in FIG. 4, an embodiment of the scheduled software delivery method can further include the steps of:
Step 402: the server maintaining a database of client devices connected to the network;
Step 404: the server querying the database and generating a list of requesting client devices to receive the broadcast;
Step 406: the steps of the server notifying the client devices further includes the steps of the server notifying the client devices on said generated list of a particular time at which the application delivery will take place;
Step 408: the steps of each client device joining the broadcast reception group further includes the steps of each client device on said generated list joining a broadcast reception group when the clock in each client device on the list indicates said particular time;
Step 410: on or about the particular time, the server performing a single transmission process to broadcast/multicast the application over the delivery network to the clients;
Step 412: client devices receive the broadcast/multicast and each client device checks the received application;
Step 414: if the received application is not satisfactory, the client devices requests the application from the server again. The client device requests the server for another transmission such that the server repeats the transmission until all such client device requests have been fulfilled.

As such, according to the present invention, using the synchronization scheme and a broadcast protocol, many STBs receive the data sent in one request. Therefore, the present invention uses Out of Band (OB) methodology efficiently, and does not occupy In Band channels. Further, the present invention allows the software down to succeed with one transmission of the download data.

Though in the above description the scheduled download process is described in conjunction with software delivery for OCAP, those skilled in the art will recognize that the present invention can be applied to delivering other kinds of data from a server to a client using a process according to the present invention.

The present invention has been described in considerable detail with reference to certain preferred versions thereof; however, other versions are possible. Therefore, the spirit and scope of the appended claims should not be limited to the description of the preferred versions contained herein.

What is claimed is:

1. A method for delivering an application from a server to multiple client devices through a delivery network, comprising the steps of:
synchronizing a clock in each user device with a universal time at the server;
maintaining the universal time in each client device in order to maintain synchronization with the sever;
the server notifying the client devices of a particular time at which the application delivery will take place;
each client device joining a broadcast reception group when the clock in each client device indicates said particular time;
on or about the particular time, the server performing a single transmission process to broadcast the application over the delivery network; and
each client device receiving the application broadcast from the sever over the delivery network at the particular time.

2. The method of claim 1, wherein the steps of the sever performing a single transmission process further includes the steps of the server performing communication between the server and the client devices for data transfer.

3. The method of claim 1 wherein:
the server comprises a cable headend;
each client device comprises a user set top box; and
the delivery network comprises a cable plant connecting the cable headend and the set top boxes.

4. The method of claim 3 wherein multiple client devices receive the data sent from the server.

5. The method of claim 1 further comprising the steps of:
the server maintaining a database of client devices connected to the network;
the server querying the database and generating a list of client devices to receive the broadcast;
the steps of the server notifying the client devices further includes the steps of the server notifying the client devices on said generated list of a particular time at which the application delivery will take place;
the steps of each client device joining the broadcast reception group further includes the steps of each client device on said generated list joining a broadcast reception group when the clock in each client device on the list indicates said particular time.

6. The method of claim 5 further including the steps of:
each client device receiving the application performing a check on the application, and if the application does not check, then the client device requesting the sever for another transmission such that the server repeats the transmission until all such client device requests have been fulfilled.

7. The method of claim 5 further comprising the steps of the server receiving a request to deliver an application to each of multiple client devices.

8. The method of claim 5 further including the steps of the server receiving multiple requests at different times and the server notifying the client devices of a particular time at which the application delivery to the client devices will take place.

9. The method of claim 8 wherein application delivery to the client devices takes place at the same time.

10. A method for delivering an application from a server to multiple client devices through a delivery network, comprising the steps of:
synchronizing each user device with the server;
the server receiving requests to deliver an application to each of multiple client devices;
the server notifying the client devices of a particular time at which the application delivery will take place; and
on or about the particular time, the server performing a single transmission process to broadcast the application over the delivery network to the client devices.

11. The method of claim 10 further including the steps of each client device receiving the application broadcast from the server over the delivery network at the particular time.

12. The method of claim 10 further including the steps of the server receiving multiple requests at different times and the server notifying the client devices of a particular time at which the application delivery to the client devices will take place.

13. The method of claim 10 wherein the steps of synchronizing further includes the steps of synchronizing a clock in each user device with a universal time at the server.

14. The method of claim 10 further including the steps of maintaining a universal time in each client device corresponding to a universal time at the server, in order to maintain synchronization with the sever.

15. The method of claim 10 wherein:
the server comprises a cable headend;
each client device comprises a user set top box; and
the delivery network comprises a cable plant connecting the cable headend and the set top boxes.

16. The method of claim 13 further comprising the steps of:
the server maintaining a database of client devices connected to the network;
the server querying the database and generating a list of client devices to receive the broadcast;
the steps of the server notifying the client devices further includes the steps of the server notifying the client devices on said generated list of a particular time at which the application delivery will take place;
each client device on said list joining a broadcast reception group when the clock in each client device on the list indicates said particular time.

17. The method of claim 16 further including the steps of:
each client device receiving the application performing a check on the application, and if the application does not check, then the client device requesting the sever for another transmission such that the server repeats the transmission until all such client device requests have been fulfilled.

18. The method of claim 10 wherein the step of the server performing a single transmission further includes the steps, on or about the particular time, the server performing a single transmission process to broadcast the application over the delivery network to the client device wherein the transmission rate is based on characteristics of client devices obtained ahead of time.

19. The method of claim 18 wherein the server broadcasts the application to the client devices at a transmission rate suitable for essentially the slowest receiving client device.

20. A system for delivering an application from a server to multiple client devices through a delivery network, comprising a controller that synchronizes each user device with the server, the server receiving requests to deliver an application to each of multiple client devices, and the controller notifying the client devices of a particular time at which the application delivery will take place, wherein on or about the particular time, the controller performs a single transmission process to broadcast the application over the delivery network to the client devices.

21. The system of claim 20 wherein each client device receives the application broadcast from the server over the delivery network at the particular time.

22. The system of claim 20 wherein the receiver receives multiple requests at different times and the controller notifies the client devices of a particular time at which the application delivery to the client devices will take place.

23. The system of claim 20 wherein the server synchronizes a clock in each user device with a universal time at the server.

24. The system of claim 20 wherein each client device maintains a universal time corresponding to a universal time at the server, in order to maintain synchronization with the sever.

25. The system of claim 20 wherein:
the server comprises a cable headend;
each client device comprises a user set top box; and
the delivery network comprises a cable plant connecting the cable headend and the set top boxes.

26. The system of claim 23 wherein:
the server maintains a database of client devices connected to the network;
the controller queries the database and generates a list of client devices to receive the broadcast;
the controller server notifies the client devices on said generated list of a particular time at which the application delivery will take place;
the client devices on said list join a broadcast reception group when the clock in each client device on the list indicates said particular time.

27. The system of claim 26 wherein each client device receives the application and performs a check on the application, and if the application does not check, then the client device requests the server for another transmission such that the server repeats the transmission until all such client device requests have been fulfilled.

28. The system of claim 20 wherein the controller performs a single transmission process to broadcast the application over the delivery network to the client device wherein the transmission rate is based on characteristics of client devices obtained ahead of time.

29. The system of claim 28 wherein the server broadcasts the application to the client devices at a transmission rate suitable for essentially the slowest receiving client device.
